(19) United States
(12) Patent Application Publication
(10) Pub. No.: US 2008/0069364 A1
(43) Pub. Date: Mar. 20, 2008

(54) Sound signal processing method, sound signal processing apparatus and computer program

(75) Inventors: Taisuke Itou, Kawasaki (JP); Shoji Hayakawa, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/698,059

(22) Filed: Jan. 26, 2007

(30) Foreign Application Priority Data
Sep. 20, 2006 (JP) 2006-254931

(51) Int. Cl. H04R 5/00

(52) U.S. Cl. 381/17

(57) ABSTRACT

A sound signal processing apparatus creates frames from acquired sound data, and converts a sound signal into a spectrum on a frame-by-frame basis. Then, the sound signal processing apparatus calculates a spectral envelope based on the spectrum, removes the spectral envelope from the spectrum, detects a spectral peak in the spectrum obtained by the removal of the spectral envelope, and suppresses the detected spectral peak. The sound signal processing apparatus determines a voice interval from the spectrum with the suppressed spectral peak, and executes voice recognition processing based on the spectrum with the suppressed spectral peak in a frame determined to be a voice interval.

### CROSS-REFERENCE TO RELATED APPLICATION

This non-provisional application claims priority under 35 U.S.C. §119(a) on Patent Application No. 2006-254931 filed in Japan on Sep. 20, 2006, the entire contents of which are hereby incorporated by reference.

### BACKGROUND OF THE INVENTION

1. Field of the Invention

The present invention relates to a sound signal processing method for executing signal processing by converting a sound signal based on acquired sound into a spectrum, a sound signal processing apparatus adopting the sound signal processing method, and a computer program for realizing the sound signal processing apparatus, and more particularly relates to suppression of non-stationary noise, such as electronic sound of a device included in the sound inputted from input means such as a microphone, and the sirens of emergency vehicles.

2. Description of Related Art

For example, in a voice recognition function installed in an apparatus such as a car navigation system, the voice recognition performance is greatly influenced by whether or not it is possible to detect a voice interval including voice accurately. Mainstream methods of detecting a voice interval include, for example, a method of detecting a voice interval by determining a sound signal to be voice when power calculated as a square of the amplitude along a time axis direction of a spectrum obtained by converting the sound signal by a conversion method such as the FFT (First Fourier Transform) is equal to or greater than a predetermined threshold value; a method of detecting a voice interval by extracting the periodicity of a sound signal called pitch and determining that the sound signal is voice when pitch exists; and a combination of these methods.

Here, the voice recognition processing of a conventional voice recognition system will be explained. FIG. 1 is a flowchart showing conventional voice recognition processing. The voice recognition system acquires sound including voice and noise with a microphone (S101), converts a sound signal based on the acquired sound into a spectrum on a frame-by-frame basis segmented at a predetermined time interval, and extracts the feature amounts such as the power, pitch, cepstrum, etc. from the converted spectrum (S102).

Further, the voice recognition system detects a frame equal to or greater than a voice interval detection threshold value from the power and pitch as the extracted feature amounts, and determines whether or not the detected frame continues for a certain period or more in order to determine a voice interval from the acquired sound (S103).

Then, by collating the feature amounts of the frame determined to be a voice interval with an acoustic model and a language dictionary, the voice recognition system recognizes the voice in the voice interval (S104).

In the voice recognition processing as shown in FIG. 1, electronic sound, such as the sound caused by operating a button of a car navigation system, has some power and pitch. Therefore, when the voice recognition system acquires an individual electronic sound, there is a problem that the electronic sound tends to be mistakenly determined to be voice.

Hence, Japanese Patent Application Laid-Open No. 08-265457 (1996) discloses a method which uses the characteristic that a small number of peaks exist in electronic sound (tone signal) and, determines electronic sound by the detection of a spectral peak.

Moreover, Japanese Patent Application Laid-Open No. 2003-58186 discloses a noise suppression method for suppressing the siren sound of emergency vehicles.

Further, Japanese Patent Application Laid-Open No. 2005-257805 discloses a method of suppressing not only non-stationary noise such as the electronic sound, the siren sound, but also periodic noise.

### BRIEF SUMMARY OF THE INVENTION

However, in the conventional method disclosed in Japanese Patent Application Laid-Open No. 08-265457 (1996), there is a problem that the accuracy of detecting a spectral peak of electronic sound is decreased under an environment where noise, such as the engine sound of vehicles and the sound of air conditioners, occurs.

Here, the problems of Japanese Patent Application Laid-Open No. 08-265457 (1996) are explained using FIGS. 2A and 2B. FIGS. 2A and 2B are views showing a spectrum. FIG. 2A is a chart showing the relationship between frequency and power under an environment where there is no noise caused by the engine sound of vehicles, and FIG. 2B is a chart showing the relationship between frequency and power under an environment where there is noise caused by the engine sound. As shown in FIG. 2A, under an environment where there is no noise caused by the engine sound, two sharp peaks with a narrow band width, which are not smaller than a threshold value indicated by the dotted line, appear clearly, and they are highly accurately detectable as noise caused by electronic sound. However, as shown in FIG. 2B, under an environment where there is noise caused by the engine sound of vehicles as indicated by the dotted line, moderate peaks with a wide band width resulting from the engine sound occur in low frequency bands, and therefore two peaks resulting from electronic sound are unclear. Thus, the accuracy of detecting peaks is lower by just using the method in which the threshold value and power are simply compared.

In the method disclosed in Japanese Patent Application Laid-Open No. 2003-58186, it is necessary to extract the fundamental frequency of the siren sound, and it is necessary to calculate an average spectrum from the past frames. Thus, there is a problem that this method can suppress only previously learned periodic noise.

In the method disclosed in Japanese Patent Application Laid-Open No. 2005-257805, there is a problem that a microphone for collecting noise to be suppressed is additionally required.

The present invention has been made with the aim of solving the above problems, and it is an object of the invention to provide a sound signal processing method capable of highly accurately detecting and suppressing a peak of non-stationary noise such as electronic sound and siren sound even under an environment where stationary noise, such as the sound of engine and the sound of air conditioners, occurs by calculating a spectral envelope from a spectrum, removing the spectral envelope from the spectrum, detecting a spectral peak based on a spectrum obtained by removing the spectral envelope, and suppressing the spectral peak, without requiring prior learning or requiring a microphone for collecting noise, and to provide a sound signal processing apparatus adopting the sound signal processing method, and a computer program for realizing the sound signal processing apparatus.

A sound signal processing method according to a first aspect is a sound signal processing method for executing signal processing by converting a sound signal based on acquired sound into a spectrum, and characterized by calculating a spectral envelope based on the spectrum; removing the spectral envelope from the spectrum; detecting a spectral peak from the spectrum obtained by the removal of the spectral envelope; and suppressing the detected spectral peak.

In this invention, by detecting a spectral peak after removing the spectral envelope, it is possible to detect sharp peaks of electronic sound, etc. without the bad influence of moderate peaks of the engine sound, the sound of air conditioners, etc. which occur in low frequency bands. It is therefore possible to highly accurately detect peaks and remove noise. Moreover, prior learning is not required, and also a microphone for collecting noise is not required.

A sound signal processing apparatus according to a second aspect is a sound signal processing apparatus for executing signal processing by converting a sound signal based on acquired sound into a spectrum, and characterized by comprising: envelope calculating means for calculating a spectral envelope based on the spectrum; envelope removing means for removing the spectral envelope from the spectrum; detecting means for detecting a spectral peak from the spectrum obtained by the removal of the spectral envelope; and suppressing means for suppressing the detected spectral peak.

In this invention, by detecting a spectral peak after removing the spectral envelope, it is possible to detect sharp peaks of electronic sound, etc. without the bad influence of moderate peaks of the engine sound, the sound of air conditioners, etc. which occur in low frequency bands. It is therefore possible to highly accurately detect peaks and remove noise. Moreover, prior learning is not required, and also a microphone for collecting noise is not required.

A sound signal processing apparatus according to a third aspect is based on the second aspect, and characterized in that the envelope calculating means calculates a cepstrum from a spectrum obtained by converting the sound signal by a first conversion, and calculates a spectral envelope by converting a lower-order component than a predetermined order of the calculated cepstrum by a second conversion that is inverse conversion of the first conversion.

In this invention, a spectral envelope showing an outline of the spectrum is calculated by the first conversion such as FFT, and the second conversion such as inverse FFT.

A sound signal processing apparatus according to a fourth aspect is based on the second aspect or the third aspect, and characterized in that the detecting means detects a band showing a value greater than a predetermined threshold value as a band including a spectral peak for the spectrum obtained by the removal of the spectral envelope.

In this invention, it is possible to detect a spectral peak by comparison with the threshold value.

A sound signal processing apparatus according to a fifth aspect is based on the second aspect or the third aspect, and characterized in that the detecting means detects a band in which the ratio between a total value of values in a band with a predetermined width and a total value of values in all bands except for the predetermined width shows a value greater than a predetermined threshold value as a band including a spectral peak for the spectrum obtained by the removal of the spectral envelope.

In this invention, by performing comparison with the spectral power in all bands and extracting peaks from a band with strong power instead of simply extracting a peak from a band with a high spectral peak, it is possible to detect apparent peaks in view of all bands.

A sound signal processing apparatus according to a sixth aspect is based on any one of the second to fifth aspects, and characterized in that the suppressing means suppresses a spectral peak by substituting a value equal to or greater than a threshold value among values of the spectrum of a band including the detected spectral peak with a value based on the threshold value.

In this invention, by substituting the value of a spectral peak based on noise, such as electronic sound, with the threshold value, it is possible to remove the peak and suppress the noise.

A sound signal processing apparatus according to a seventh aspect is based on any one of the second to fifth aspects, and characterized in that the suppressing means suppresses a spectral peak by substituting a value equal to or greater than the spectral envelope among values of the spectrum of a band including the detected spectral peak with a value based on the spectral envelope.

In this invention, by substituting the value of a spectral peak based on noise, such as electronic sound, with a value based on the spectral envelope, it is possible to remove the peak and suppress the noise.

A sound signal processing apparatus according to an eighth aspect is based on any one of the second to fifth aspects, and characterized in that the suppressing means suppresses a spectral peak by substituting values of the spectrum of a band including the detected spectral peak with a total value of values in a wider band than the band including the detected spectral peak.

In this invention, by substituting the value of a spectral peak based on noise, such as electronic sound, with the total value or, for example, the average value of the values in a band with several 100 Hz width around the spectral peak, it is possible to remove the peak and suppress the noise.

A sound signal processing apparatus according to a ninth aspect is based on any one of the second to eighth aspect, and characterized by further comprising means for executing voice recognition processing, based on the sound signal with the suppressed spectral peak.

In this invention, it is possible to execute voice recognition processing highly accurately, based on a sound signal from which noise such as electronic sound was removed.

A computer program according to a tenth aspect is a computer program for causing a computer to execute signal processing by converting a sound signal based on acquired sound into a spectrum, and characterized by executing a step of causing the computer to calculate a spectral envelope based on the spectrum; a step of causing the computer to remove the spectral envelope from the spectrum; a step of causing the computer to detect a spectral peak from the spectrum obtained by the removal of the spectral envelope; and a step of causing the computer to suppress the detected spectral peak.

In this invention, by executing the computer program with a computer such as a navigation device, the computer operates as a sound signal detection apparatus. By detecting a spectral peak after removing the spectral envelope, it is possible to detect sharp peaks of electronic sound, etc., without the bad influence of moderate peaks of the sound of engine, sound of air conditioners, etc. which occur in low frequency bands, and thus it is possible to highly accurately detect peaks and remove noise. Moreover, prior leaning is not required, and also a microphone for collecting noise is not required.

A sound signal detection method, a sound signal detection apparatus, and a computer program according to the present invention convert a sound signal based on acquired sound into a spectrum by a process such as the FFT; calculate a spectral envelope from the spectrum; remove the spectrum envelope from the spectrum; detect a spectrum peak from the spectrum obtained by the removal of the spectrum envelope, and suppress the detected spectral peak.

In this structure, since spectral peaks are detected after removing the spectral envelope, it is possible to remove the spectral envelope that is an outline of the spectrum and use the fine structure of the spectrum for the detection of spectral peaks. Therefore, since it is possible to detect sharp peaks of electronic sound, etc., without the bad influence of moderate peaks of the sound of engine, sound of air conditioners, etc. which occur in low frequency bands, the present invention produces advantageous effects of capable of highly accurately detecting peaks and removing noise. Moreover, the present invention also produces advantageous effects of capable of eliminating the necessity of prior leaning and a microphone for collecting noise.

In particular, when the present invention is applied to a car navigation system with a voice recognition function that is installed in vehicles, since the detection and suppression of spectral peaks of non-stationary noise, such as electronic sound and siren sound, are highly accurately realized even under an environment where stationary noise such as the engine sound of vehicles and the sound of air conditioners occurs, noise such as electronic sound and siren sound will never be misrecognized as voice. It is thus possible to produce advantageous effects, such an improvement of the accuracy of recognizing voice.

The above and further objects and features of the invention will more fully be apparent from the following detailed description with accompanying drawings.

### BRIEF DESCRIPTION OF THE SEVERAL VIEWS OF THE DRAWINGS

FIG. 1 is a flowchart showing conventional voice recognition processing;

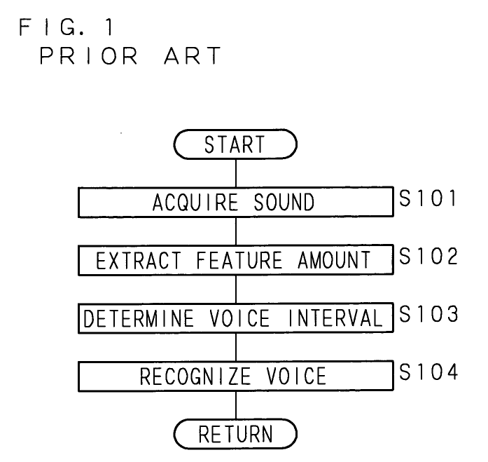

FIGS. 2A and 2B are views showing a spectrum;

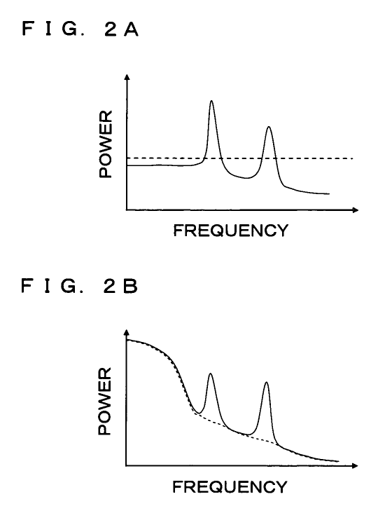

FIG. 3 is a block diagram showing a structural example of a sound signal processing apparatus according to Embodiment 1 of the present invention;

FIG. 4 is a flowchart showing an example of processing performed by the sound signal processing apparatus according to Embodiment 1 of the present invention;

FIG. 5 is a view showing one example of a spectrum of the sound signal processing apparatus according to Embodiment 1 of the present invention;

FIGS. 6A and 6B are waveform charts showing one example of a sound signal of the sound signal processing apparatus according to Embodiment 1 of the present invention;

FIG. 7 is a view showing one example of a spectrum of a sound signal processing apparatus according to Embodiment 2 of the present invention; and

FIG. 8 is a view showing one example of a spectrum of a sound signal processing apparatus according to Embodiment 3 of the present invention.

### DETAILED DESCRIPTION OF THE INVENTION

The following description will explain the present invention in detail, based on the drawings illustrating some embodiments thereof.

### Embodiment 1

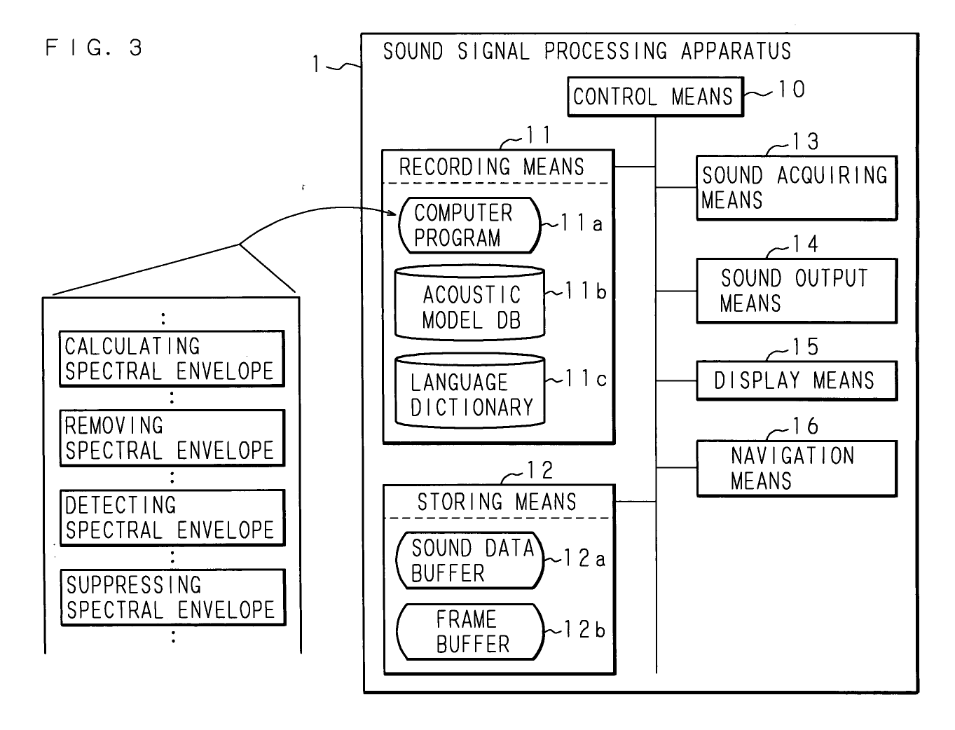

FIG. 3 is a block diagram showing a structural example of a sound signal processing apparatus according to Embodiment 1 of the present invention. In FIG. 3, 1 represents a sound signal processing apparatus using a computer, such as, for example, a navigation device installed in a vehicle, and the sound signal processing apparatus 1 comprises as least control means 10 (controller) such as a CPU (Central Processing Unit) and a DSP (Digital Signal Processor) for controlling the entire apparatus; recording means 11 such as a hard disk and a ROM for recording various kinds of information such as programs and data; storing means 12 such as a RAM for storing temporarily created data; sound acquiring means 13 such as a microphone for acquiring sound from outside; sound output means 14 such as a speaker for outputting sound; display means 15 such as a liquid crystal monitor; and navigation means 16 for executing processing related to navigation such as indicating a route to a destination.

A computer program 11a of the present invention is recorded in the recording means 11, and a computer operates as the sound signal processing apparatus 1 of the present invention by storing various kinds of processing steps contained in the recorded computer program 11a into the storing means 12 and executing them under the control of the control means 10.

A part of the recording area of the recording means 11 is used as various kinds of databases, such as an acoustic model database (acoustic model DB) 11b recording acoustic models for voice recognition, and a language dictionary 11c recording recognizable vocabulary described by phonemic or syllabic definitions corresponding to the acoustic models, and grammar.

A part of the storing means 12 is used as a sound data buffer 12a for storing digitized sound data obtained by sampling sound that is an analog signal acquired by the sound acquiring means 13 at a predetermined period, and a frame buffer 12b for storing frames obtained by dividing the sound data into a predetermined time length.

The navigation means 16 includes a position detecting mechanism such as a GPS (Global Positioning System), and a recording medium such as a DVD and a hard disk recording map information. The navigation means 16 executes navigation processing such as searching for a route from the current location to a destination and indicating the route, displays a map and the route on the display means 15, and outputs a voice guide from the sound output means 14.

The structural example shown in FIG. 3 is merely one example, and it is possible to expand the present invention in various forms. For example, it may be possible to construct a function related to sound signal processing as a single or a plurality of VLSI chips, and includes it in a navigation device, or it may be possible to externally mount a device for sound signal processing exclusive use on the navigation device. It may also be possible to use the control means 10 for both of the sound signal processing and the navigation processing, or it may be possible to provide a circuit of exclusive use for each processing. Further, it may be possible to incorporate into the control means 10 a co-processor for executing processing such as specific calculation related to sound signal processing, for example, later-described FFT (Fast Fourier Transformation) and inverse FFT. Alternatively, it may be possible to construct the sound data buffer 12a as an accessory circuit of the sound acquiring means 13, and to construct the frame buffer 12b on the memory of the control means 10. The sound signal processing apparatus 1 of the present invention is not limited to an on-vehicle device such as a navigation device, and may be used in devices for various applications for performing voice recognition, such as telephones.

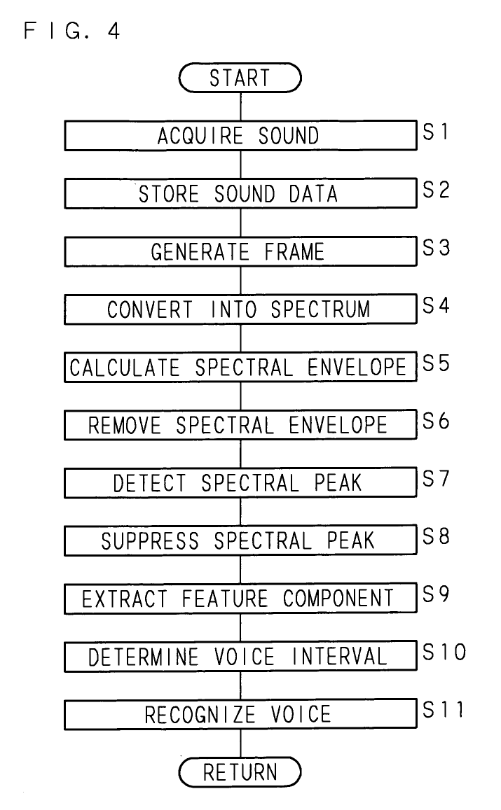

The following description will explain the processing performed by the sound processing apparatus 1 according to Embodiment 1 of the present invention. FIG. 4 is a flowchart showing one example of processing performed by the sound signal processing apparatus 1 according to Embodiment 1 of the present invention. Under the control of the control means 10 that executes the computer program 11a, the sound signal processing apparatus 1 acquires outside sound by the sound acquiring means 13 (step S1), and stores digitized sound data obtained by sampling the acquired sound, that is, an analog signal at a predetermined period in the sound data buffer 12a (step S2). The outside sound to be acquired in step S1 includes superimposed sound of various sounds such as human voice, stationary noise and non-stationary noise. The human voice is a voice to be recognized by the sound signal processing apparatus 1. The stationary noise is noise such as the engine sound of vehicles and the sound of air conditioners. The non-stationary noise is noise such as electronic sound that occurs when electronic equipment is operated, and the sound of siren.

The sound signal processing apparatus 1 generates frames of a predetermined length from the sound data stored in the sound data buffer 12a, under the control of the control means 10 (step S3). In step S3, the sound data is divided into frames by a predetermined length of 20 ms to 30 ms, for example. The respective frames overlap each other by 10 ms to 15 ms. For each of the frames, frame processing general to the field of voice recognition, including window functions such as a Hamming window and a Hanning window, and filtering with a high pass filter, is performed. The following processing is performed on each of the frames thus created.

Under the control of the control means 10, the sound signal processing apparatus 1 converts a sound signal based on the sound data of each frame into a spectrum by performing FFT processing (step S4). In step S4, the sound signal processing apparatus 1 finds a power spectrum by squaring an amplitude spectrum X(ω) obtained by performing the FFT processing on the sound signal, and calculates a logarithmic power spectrum 20 log₁₀|X(ω)| as the logarithm of the found power spectrum. In this manner, the sound signal is converted into a logarithmic power spectrum. Note that, in step S4, it may be possible to calculate a logarithmic amplitude spectrum 10 log₁₀|X(ω)| as the logarithm of the amplitude spectrum X(ω) obtained by performing FFT processing on a sound signal, and use the calculated logarithmic amplitude spectrum as a spectrum after conversion.

Under the control of the control means 10, the sound signal processing apparatus 1 converts the spectrum based on the Fourier transform of the sound signal into a cepstrum, and calculates a spectral envelope by performing inverse FFT processing on a lower-order component than a predetermined order of the converted cepstrum (step S5).

The processing in step S5 will be explained. The amplitude spectrum |X(ω)| obtained by performing FFT processing on the sound signal is expressed by Equation 1 below, using G(ω) and H(ω) representing the FFTs of higher-order component and lower-order component, respectively.

X(ω)=G(ω)H(ω) Equation 1

The logarithm of Equation 1 can be expressed by Equation 2 below.

log₁₀|X(ω)|=log₁₀|G(ω)|+log₁₀|H(ω)| Equation 2

A cepstrum c (τ) is obtained by the inverse FFT of Equation 2 by using the frequency co as a variable. The first term of the right side of Equation 2 shows a fine structure that is a higher-order component of the spectrum, and the second term of the right side shows a spectral envelope that is a lower-order component of the spectrum. In other words, in step S5, a spectral envelope is calculated by performing the inverse FFT of a lower-order component than a predetermined order, such as a component lower than the 10th order or 20th order of the FFT cepstrum calculated from the FFT spectrum. Note that although there is a method using a spectral envelope using an LPC (Linear Predictive Coding) cepstrum, this method gives an envelope with enhanced peaks, and therefore the FFT cepstrum is preferable.

The sound signal processing apparatus 1 removes the spectral envelope calculated in step S5 from the spectrum found in step S4 under the control of the control means 10 (step S6). The removal operation in step S6 is carried out by subtracting the values of the respective frequencies in the spectral envelope from the values of the respective frequencies in the spectrum found in step S4. By removing the spectral envelope from the spectrum in step S6, the tilt of the spectrum is removed and the spectrum becomes flat, and thus the fine structure of the spectrum is found as a result of processing. Note that it may be possible to calculate the spectral fine structure by performing the inverse FFT on a higher-order component such as a component of not lower than the 11th order or 21st order of the FFT cepstrum, which was not used in calculating the spectral envelope, instead of removing the spectral envelope from the spectrum.

Under the control of the control means 10, the sound signal processing apparatus 1 detects a spectral peak in the spectrum obtained by the removal of the spectral envelope (step S7), and suppresses the detected spectral peak (step S8).

In step S7, when detecting a spectral peak, a band including a spectral peak showing a greater value than a predetermined threshold value recorded in the recording means 11 is detected as a band including a spectral peak to be suppressed. Alternatively, a band including n (n is a natural number) peaks from the largest peak as the spectral peak to be suppressed may be detected. Further, it may be possible to detect a band including a maximum of n peaks from the largest value of spectral peaks among spectral peaks showing greater values than the predetermined threshold value as the spectral peaks to be suppressed. Note that the value of n is appropriately around 2 to 4.

As the method of suppressing the spectral peak in step S8, some methods are listed below as examples. The first suppression method is a method in which the values of power equal to or higher than the threshold value in a band including the detected spectral peak are converted into the threshold value, that is, power corresponding to the threshold value and greater values is subtracted from the spectrum. It is not necessarily to convert the values equal to or higher than the threshold value into the threshold value, and it may be possible to convert the values into a value based on the threshold value, for example, a value greater than the threshold value by a predetermined value.

The second suppression method is a method in which a power value equal to or higher than the spectral envelope in a peripheral band including the detected spectral peak, for example, a band with a width of several 100 Hz around the spectral peak, is converted into a corresponding spectral envelope value.

The third suppression method is a method in which the values in a band between points at which the detected spectral peak crosses the spectral envelope, that is, a band in which the value of power forming the spectral peak exceeds the spectral envelope and then becomes lower than the spectral envelope, are converted into a value of the corresponding spectral envelope.

The fourth suppression method is a method of suppressing a spectral peak by converting the value of power in a band including the detected spectral peak with the total value or, for example, the average value of the values in a band wider than the band including the detected spectral peak, for example, a band with a width of several 100 Hz around the spectral peak.

Under the control of the control means 10, the sound signal processing apparatus 1 extracts feature components such as power obtained by integrating a power spectrum with the suppressed spectral peak in the frequency axis direction, pitch, and cepstrum (step S9), and determines a voice interval based on the extracted spectral power and pitch (step S10). Regarding the determination of a voice interval in step S10, the spectral power calculated in step S9 is compared with a threshold value for voice detection recorded in the recording means 11, and, if spectral power equal to or greater than the threshold value exists and pitch exists, the interval is determined to be a voice interval.

Then, under the control of the control means 10, the sound signal processing apparatus 1 refers to the acoustic models recorded in the acoustic model database 11b and the recognizable vocabulary and grammar recorded in the language dictionary 11c, based on a feature vector that is a feature component extracted from the spectrum obtained by suppressing the spectral peak, and executes voice recognition processing on a frame determined to be a voice interval (step S11). The voice recognition processing in step S11 is executed by calculating the similarity with respect to the acoustic models and referring to language information about the recognizable vocabulary.

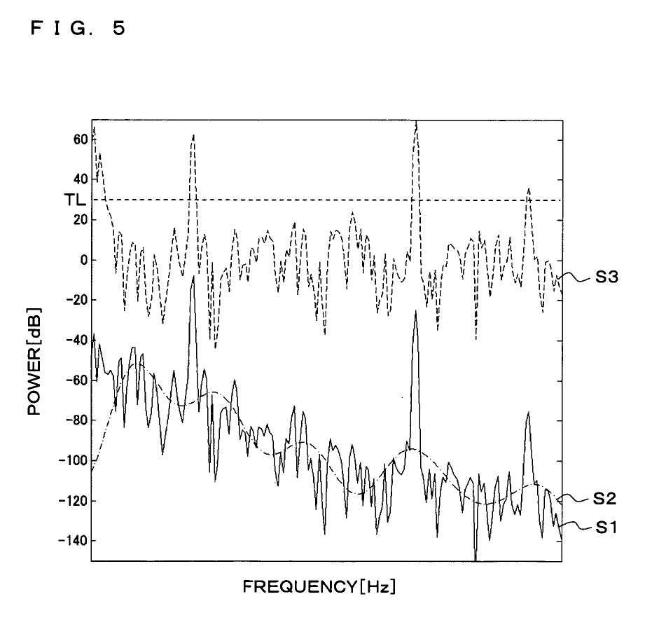

FIG. 5 is a view showing one example of a spectrum of the sound signal processing apparatus 1 according to Embodiment 1 of the present invention. In FIG. 5, the frequency is plotted on the horizontal axis and the power of the spectrum is plotted on the vertical axis to show their relationship. The solid line in FIG. 5 indicates a power spectrum S1, the alternate long and short dash line shows a spectral envelope S2 calculated based on the power spectrum S1, and the dotted line shows a fine structure S3 of the spectrum obtained by removing the spectral envelope S2 from the power spectrum S1. Moreover, 30 dB shown as TL (Threshold Level) is set as a threshold value. By removing the spectral envelope S2 from the power spectrum S1 as shown in FIG. 5, the tilt of the power spectrum S1 from the low frequency side to high frequency side is removed, and three spectral peaks included in the fine structure S3 of the spectrum are clear. When detecting spectral peaks from the fine structure S3, it is preferable to exclude a band frequency 100 Hz at the bottom and top of frequency from the target of detection because it is influenced by a band-pass filter during digital signal processing, electronic sound does not exist in low frequency bands, the accuracy of the spectral envelope S2 is lower, or other reason.

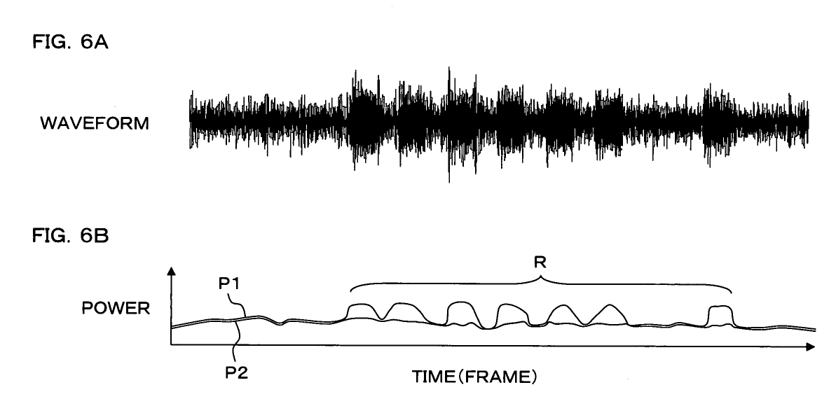

FIGS. 6A and 6B are waveform charts showing one example of a sound signal of the sound signal processing apparatus 1 according to Embodiment 1 of the present invention. FIG. 6A shows a change of the amplitude of a sound signal segmented as a frame with time, and FIG. 6B shows the outline of power obtained by squaring the amplitude of the sound signal of FIG. 6A. In FIG. 6B, P1 shows the outline of power before removing the spectral envelope, and P2 shows the outline of power after removing the spectral envelope. As shown in FIG. 6B, moderate peaks resulting from stationary noise, such as the engine sound, superimposed in FIG. 6A appear in a segment R in P1, but they are removed in P2.

Thus, in Embodiment 1 of the present invention, it is possible to detect peaks caused by non-stationary noise having a sharp peaks, such as electronic sound and the siren sound, by removing stationary noise even under a stationary noise environment having moderate peaks such as the engine sound and the sound of air conditioners, and it is possible to suppress the detected peaks. It is therefore possible to prevent non-stationary noise from being misrecognized as voice. Although the spectrum of voice (a vowel) has a plurality of peaks, they are removed as a spectral envelope because the peaks are not sharp compared with electronic sound, and thus the peaks of the vowel will never be mistakenly suppressed.

### Embodiment 2

Embodiment 2 is an embodiment configured by modifying the spectral peak detection method of Embodiment 1. Since the structural example of a sound signal processing apparatus of Embodiment 2 is the same as in Embodiment 1, the explanation thereof is omitted by referring to Embodiment 1. In the following explanation, the structure of the sound signal processing apparatus is illustrated by adding the same codes as in Embodiment 1. Moreover, since the processing performed by the sound signal processing apparatus 1 of Embodiment 2 is the same as that in Embodiment 1, the explanation thereof is omitted by referring to Embodiment 1. In the following explanation, the respective processes to be performed by the sound signal processing apparatus 1 are explained by adding the same step numbers as in Embodiment 1.

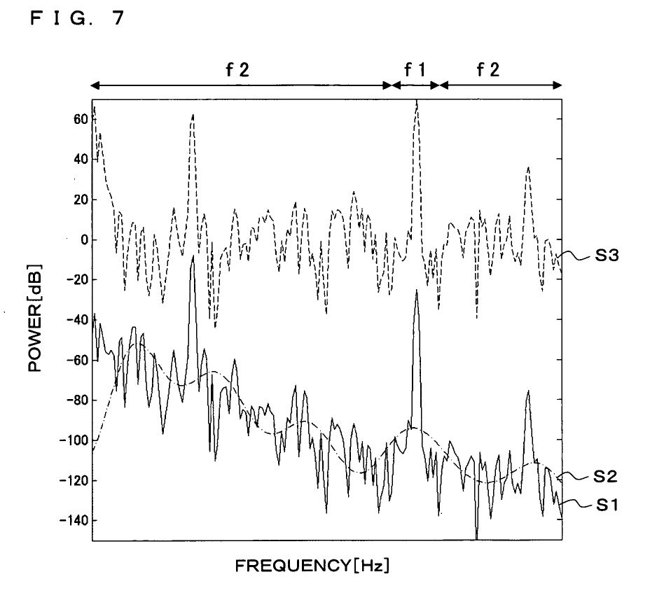

FIG. 7 is a view showing one example of a spectrum of the sound signal processing apparatus 1 according to Embodiment 2 of the present invention. In FIG. 7, the frequency is plotted on the horizontal axis and the power of the spectrum is plotted on the vertical axis to show their relationship. The solid line in FIG. 7 indicates a power spectrum S1, the alternate long and short dash line shows a spectral envelope S2 calculated based on the power spectrum S1, and the dotted line shows a fine structure S3 of the spectrum obtained by removing the spectral envelope S2 from the power spectrum S1.

As the process in step S7 of detecting a spectral peak from the spectrum obtained by removing the spectral envelope, the sound signal processing apparatus 1 of Embodiment 2 detects, as a band including a spectral peak, a band in which the ratio between a total value of the values in a band of a predetermined width and a total value of the values in all bands except for the predetermined width shows a value greater than a predetermined threshold value. More specifically, a frequency at which the power of the spectrum has a maximum value is detected, and the total value or, for example, the average value of power in a band of a predetermined width such as 100 Hz around the detected frequency is calculated. In FIG. 7, an average value P1 of power in a band indicated as f1 is calculated. Additionally, the total value or, for example, the average value of power in all bands except for f1 is calculated. In FIG. 7, an average value P2 of power in a band indicated as f2 is calculated. When the value P1/P2 representing the ratio between P1 and P2 is greater than the predetermined threshold value, the band f1 is detected as a band including a spectral peak. Further, the process of detecting a frequency with the second largest power of the spectrum is repeated to detect up to at most a predetermined number n of spectral peaks at which the value of the ratio is greater than the threshold value. The processing such as suppressing the detected spectral peak is the same as in Embodiment 1.

### Embodiment 3

Embodiment 3 is an embodiment configured by modifying the spectral peak detection method of Embodiment 1. Since the structural example of a sound signal processing apparatus of Embodiment 3 is the same as in Embodiment 1, the explanation thereof is omitted by referring to Embodiment 1. In the following explanation, the structure of the sound signal processing apparatus 1 is illustrated by adding the same codes as in Embodiment 1. Moreover, since the processing performed by the sound signal processing apparatus 1 of Embodiment 3 is the same as that in Embodiment 1, the explanation thereof is omitted by referring to Embodiment 1. In the following explanation, the respective processes to be performed by the sound signal processing apparatus 1 are explained by adding the same step numbers as in Embodiment 1.

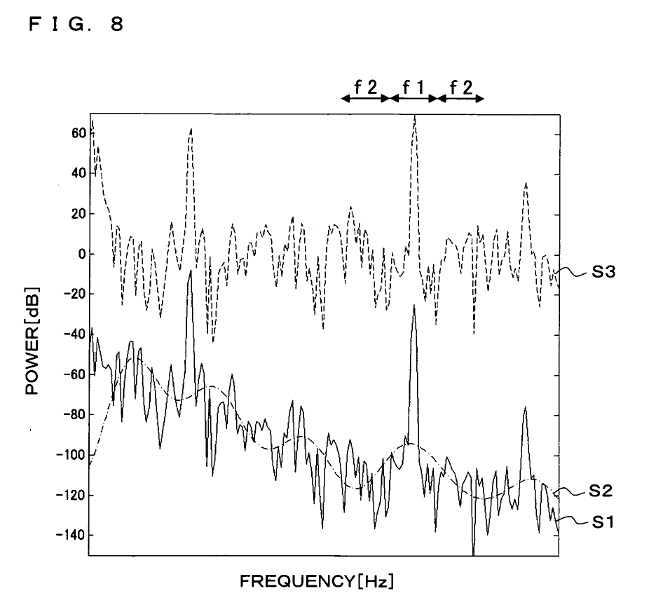

FIG. 8 is a view showing one example of a spectrum of the sound signal processing apparatus 1 according to Embodiment 3 of the present invention. In FIG. 8, the frequency is plotted on the horizontal axis and the power of the spectrum is plotted on the vertical axis to show their relationship. The solid line in FIG. 8 indicates a power spectrum S1, the alternate long and short dash line shows a spectral envelope S2 calculated based on the power spectrum S1, and the dotted line shows a fine structure S3 of the spectrum obtained by removing the spectral envelope S2 from the power spectrum S1.

As the process in step S7 of detecting a spectral peak from the spectrum obtained by removing the spectral envelope, the sound signal processing apparatus 1 of Embodiment 3 detects, as a band including a spectral peak, a first band in which the ratio between a total value of the values in the first band of a first predetermined width and a total value of the values in a second band of a second predetermined width near the first band shows a value greater than a predetermined threshold value. More specifically, a frequency at which the power of the spectrum has a maximum value is detected, and the total value or, for example, the average value of power in a band with a predetermined width, such as 100 Hz around the detected frequency, is calculated. In FIG. 8, an average value P1 of power in a band indicated as f1 is calculated. Additionally, the total value or, for example, the average value of power in a band of 150 Hz in front of and behind f1 is respectively calculated. In FIG. 8, an average value P2 of power in a band indicated as f2 is calculated. When the value P1/P2 representing the ratio between P1 and P2 is greater than the predetermined threshold value, the band f1 is detected as a band including a spectral peak. Further, the process of detecting a frequency for the second largest power of the spectrum is repeated to detect up to at most a predetermined number n of spectral peaks at which the value of the ratio is greater than the threshold value. The processing such as suppressing the detected spectral peak is the same as in Embodiment 1.

In Embodiments 1 through 3 described above, embodiments in which voice recognition is performed after removing non-stationary noise are illustrated as the invention related to voice recognition, but the present invention is not limited to these embodiments and may be expanded in various fields related to voice processing. For example, when the present invention is applied to telecommunication to transmit a sound signal based on sound acquired by a receiver device to a person you are calling, it may be possible to transmit the sound signal to the person after removing non-stationary noise from the sound signal by the processing of the present invention.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A sound signal processing method for executing signal processing by converting a sound signal based on acquired sound into a spectrum, comprising the steps of:
calculating a spectral envelope based on the spectrum;
removing the spectral envelope from the spectrum;
detecting a spectral peak from the spectrum obtained by the removal of the spectral envelope; and
suppressing the detected spectral peak.

2. A sound signal processing apparatus for executing signal processing by converting a sound signal based on acquired sound into a spectrum, comprising a controller capable of:
calculating a spectral envelope based on the spectrum;
removing the spectral envelope from the spectrum;
detecting a spectral peak from the spectrum obtained by the removal of the spectral envelope; and
suppressing the detected spectral peak.

3. The sound signal processing apparatus according to claim 2, wherein said controller is further capable of calculating a cepstrum from a spectrum obtained by converting the sound signal by a first conversion, and calculating a spectral envelope by converting a lower-order component than a predetermined order of the calculated cepstrum by a second conversion that is inverse conversion of the first conversion.

4. The sound signal processing apparatus according to claim 2, wherein said controller is further capable of subtracting a value of the spectral envelope from a value of the spectrum.

5. The sound signal processing apparatus according to claim 2, wherein said controller is further capable of detecting a band showing a value greater than a predetermined threshold value as a band including a spectral peak for the spectrum obtained by the removal of the spectral envelope.

6. The sound signal processing apparatus according to claim 2, wherein said controller is further capable of detecting a band in which a ratio between a total value of values in a band with a predetermined width and a total value of values in all bands except for the predetermined width shows a value greater than a predetermined threshold value as a band including a spectral peak for the spectrum obtained by the removal of the spectral envelope.

7. The sound signal processing apparatus according to claim 2, wherein said controller is further capable of detecting a first band in which a ratio between a total value of values in the first band with a first predetermined width and a total value of values in a second band with a second predetermined width near the first band shows a value greater than a predetermined threshold value as a band including a spectral peak for the spectrum obtained by the removal of the spectral envelope.

8. The sound signal processing apparatus according to claim 2, wherein said controller is further capable of detecting a band including a spectral peak up to at most a predetermined number of spectral peaks.

9. The sound signal processing apparatus according to claim 2, wherein said controller is further capable of suppressing a spectral peak by substituting a value equal to or greater than a threshold value among values of the spectrum of a band including the detected spectral peak with a value based on the threshold value.

10. The sound signal processing apparatus according to claim 2, wherein said controller is further capable of suppressing a spectral peak by substituting a value equal to or greater than the spectrum envelope among values of the spectrum of a band including the detected spectral peak with a value based on the spectral envelope.

11. The sound signal processing apparatus according to claim 2, wherein said controller is further capable of suppressing a spectral peak by substituting values of the spectrum of a band including the detected spectral peak with a total value of values in a wider band than the band including the detected spectral peak.

12. The sound signal processing apparatus according to claim 2, wherein said controller is further capable of executing voice recognition processing, based on the sound signal with the suppressed spectral peak.

13. A sound signal processing apparatus for executing signal processing by converting a sound signal based on acquired sound into a spectrum, comprising:
envelope calculating means for calculating a spectral envelope based on the spectrum;
envelope removing means for removing the spectral envelope from the spectrum;
detecting means for detecting a spectral peak from the spectrum obtained by the removal of the spectral envelope; and
suppressing means for suppressing the detected spectral peak.

14. The sound signal processing apparatus according to claim 13, wherein said envelope calculating means calculates a cepstrum from a spectrum obtained by converting the sound signal by a first conversion, and calculates a spectral envelope by converting a lower-order component than a predetermined order of the calculated cepstrum by a second conversion that is inverse conversion of the first conversion.

15. The sound signal processing apparatus according to claim 13, wherein said envelope removing means subtracts a value of the spectral envelope from a value of the spectrum.

16. The sound signal processing apparatus according to claim 13, wherein said detecting means detects a band showing a value greater than a predetermined threshold value as a band including a spectral peak for the spectrum obtained by the removal of the spectral envelope.

17. The sound signal processing apparatus according to claim 13, wherein said detecting means detects a band in which a ratio between a total value of values in a band with a predetermined width and a total value of values in all bands except for the predetermined width shows a value greater than a predetermined threshold value as a band including a spectral peak for the spectrum obtained by the removal of the spectral envelope.

18. The sound signal processing apparatus according to claim 13, wherein said detecting means detects a first band in which a ratio between a total value of values in the first band with a first predetermined width and a total value of values in a second band with a second predetermined width near the first band shows a value greater than a predetermined threshold value as a band including a spectral peak for the spectrum obtained by the removal of the spectral envelope.

19. The sound signal processing apparatus according to claim 13, wherein said detecting means detects a band including a spectral peak up to at most a predetermined number of spectral peaks.

20. The sound signal processing apparatus according to claim 13, wherein said suppressing means suppresses a spectral peak by substituting a value equal to or greater than a threshold value among values of the spectrum of a band including the detected spectral peak with a value based on the threshold value.

21. The sound signal processing apparatus according to claim 13, wherein said suppressing means suppresses a spectral peak by substituting a value equal to or greater than a spectral envelope among values of the spectrum of a band including the detected spectral peak with a value based on the spectral envelope.

22. The sound signal processing apparatus according to claim 13, wherein said suppressing means suppresses a spectral peak by substituting values of the spectrum of a band including the detected spectral peak with a total value of values in a wider band than the band including the detected spectral peak.

23. The sound signal processing apparatus according to claim 13, further comprising means for executing voice recognition processing, based on the sound signal with the suppressed spectral peak.

24. A recording medium for recording a computer program for causing a computer to execute signal processing by converting a sound signal based on acquired sound into a spectrum, said computer program comprising:
a step of causing the computer to calculate a spectral envelope based on the spectrum;
a step of causing the computer to remove the spectral envelope from the spectrum;
a step of causing the computer to detect a spectral peak from the spectrum obtained by the removal of the spectral envelope; and
a step of causing the computer to suppress the detected spectral peak.
